(19) United States
(12) Patent Application Publication
(10) Pub. No.: US 2025/0226749 A1
(43) Pub. Date: Jul. 10, 2025

(54) CHANGING A MASTER STAGE IN A MULTI-PHASE SWITCHING CONVERTER

(71) Applicant: Shaoxing Yuanfang Semiconductor Co., Ltd., Shaoxing (CN)

(72) Inventors: Ramkishore Ganti, Bangalore (IN); Santosh Nene, Bangalore (IN); Anil Narayan Kakade, Bangalore (IN); Suresh Venkatesan, Bangalore (IN); Junqing Teng, Shanghai (CN)

(21) Appl. No.: 18/944,013

(22) Filed: Nov. 12, 2024

(30) Foreign Application Priority Data
Jan. 10, 2024 (IN) 202441001829

(51) Int. Cl. H02M 3/158; H02M 1/00

(52) U.S. Cl. CPC H02M 3/1584; H02M 1/0009

(57) ABSTRACT

A phase controller of a multi-phase switching converter provided according to an aspect of the present disclosure provides corresponding phase control signals to multiple power stages that together operate to provide a regulated supply voltage from an input voltage. The phase controller activates a set of power stages and keeps the remaining power stages inactive. A first power stage in the set of active power stages is operated as a master stage. The phase controller changes the set of power stages when required for supporting a present load-current. When effecting such a change, if a number of stages in the set of power stages is greater than or equal to a threshold count, the phase controller selects as the master stage a power stage other than the first power stage among the changed set of power stages.

### PRIORITY CLAIM

The instant patent application is related to and claims priority from the co-pending provisional India patent application entitled, “Power-Stage Stress Levelling in Multi-Phase Buck Converters by Randomizing Phase Distribution”, Serial No.: 202441001829, Filed: 10 Jan. 2024; Attorney docket no.: AURA-355-INPR, which is incorporated in its entirety herewith to the extent not inconsistent with the description herein.

### BACKGROUND

### Technical Field

Embodiments of the present disclosure relate generally to multi-phase switching converters, and more specifically to changing a master stage in a multi-phase switching converter.

### Related Art

Switching converters refer to components which convert an input AC (alternating current) or DC (direct current) voltage of one magnitude to an output DC voltage of a desired magnitude by employing and operating switch(es), as is well known in the relevant arts. Switching converters find use as, for example, stand-alone power supplies, in voltage regulator modules used in several environments such as laptops, mobile phones, etc.

A switching converter often employs multiple power stages, which together generate the regulated DC voltage. Such employed power stages are termed as active stages in the corresponding duration of operation. Each active power stage generates a corresponding part of the requisite load current in a respective phase of a sequence of phases, and thus such a switching converter is referred to as a multi-phase switching converter.

Power stages are controlled by a phase controller using respective phase control signals. The phase controller controls the addition and dropping/shedding of power stages based on factors such as load-current requirements, which implies that the set of active stage changes depending on the added/dropped stages.

The phase controller may operate one of the power stages as a ‘master stage’ in a given duration, which implies that such a power stage is always included in the set of active stages even as there are additions and/or droppings of stages in that given duration. Thus, the master stage remains active in that entire (given) duration irrespective of the load-current.

There is a general recognized need to change the master stage in a multi-phase switching converter. Aspects of the present disclosure are directed to changing a master stage in a multi-phase switching converter.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a multi-phase switching converter in an embodiment of the present disclosure.

FIG. 3 is a flow-chart illustrating the manner in which a phase controller operates to change the master stage of the multi-phase switching converter, according to an aspect of the present disclosure.

FIG. 4 is a block diagram illustrating the implementation of a phase controller in an embodiment of the present disclosure.

FIG. 5 is a block diagram illustrating the implementation of a phase distributor in a phase controller, in an embodiment of the present disclosure.

FIG. 6 is a block diagram illustrating the implementation of a ring cell in an embodiment of the present disclosure.

FIG. 7 is a timing diagram (not to scale) illustrating phase management and change in master stage, in an embodiment of the present disclosure.

FIGS. 8A and 8B depict tables illustrating changing the master stage in two example scenarios, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A phase controller of a multi-phase switching converter provided according to an aspect of the present disclosure provides corresponding phase control signals to multiple power stages that together operate to provide a regulated supply voltage from an input voltage. The phase controller activates a set of power stages and keeps the remaining power stages inactive. A first power stage in the set of active power stages is operated as a master stage. The phase controller changes the set of power stages when required for supporting a present load-current. When effecting such a change, if a number of stages in the set of power stages is greater than or equal to a threshold count, the phase controller selects as the master stage a power stage other than the first power stage among the changed set of power stages.

It may be appreciated that changing the master stage reduces stress on a single power stage that may otherwise be operated continuously as the master stage. Further, it may also be appreciated that selecting a previously active stage as a new master stage, when the number of active power stages exceeds a threshold count, may prevent transients in the regulated supply voltage.

A phase controller according to another aspect contains a phase activator and a master-phase selector. The phase activator receives information comprising present load-current requirement and generates active-phases signal indicating a set of power stages to be driven to an active state to support the requirement. The master-phase selector receives the active-phases signal and generates a master-phase signal indicating the power stage in the set of power stages to be operated as a master stage. The phase activator changes the set of power stages when required for supporting the present load-current. If the number of stages is greater than or equal to a threshold count, the master-phase selector selects, among the changed set of power stages, a power stage other than the first power stage as the master stage.

According to another aspect of the present disclosure, the phase controller contains a master-control-signal generator block that receives the regulated supply voltage and a reference voltage of a desired magnitude, and generates a common control signal having transitions with a period generated based on difference in magnitude between the reference voltage and the regulated supply voltage. A phase distributor of the phase controller receives the common control signal and generates the corresponding phase control signals timed according to the transitions of the common control signal.

According to another aspect of the present disclosure, the multi-phase switching converter comprises multiple rails with a corresponding master stage operable for each rail. In an embodiment, the threshold count equals a total number of power stages such that the master stage corresponding to a first rail is changed only when all power stages assigned to the first rail are operative as the changed set of power stages, wherein the first rail provides the regulated supply voltage.

In an embodiment, the master-phase selector selects the master stage in a round-robin sequence among power stages in the changed set of power stages.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

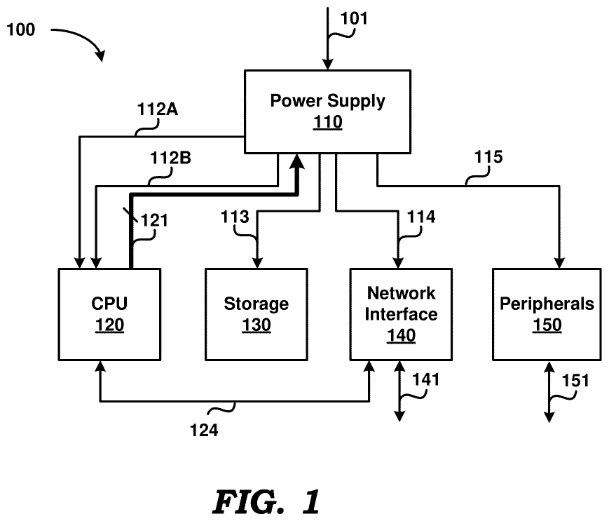

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as, for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provide two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as, for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 responds to signals from CPU 120 received on path 121 to control the multi-phase converters to reduce/increase current output based on the specific signal (e.g., PS1, PS2 and PS3).

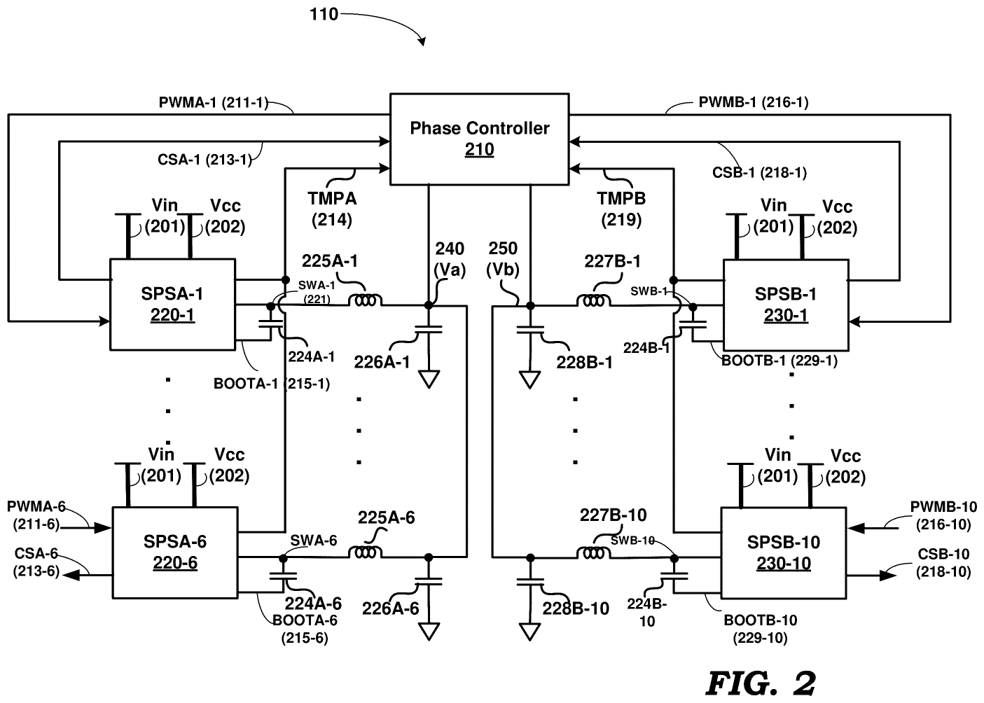

In the embodiment, power supply 110 is a voltage regulator module (VRM), sometimes also called processor power module (PPM), and contains one or more step-down switching (buck) converters to generate several smaller voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM implemented as a multi-phase switching converter as shown in FIG. 2.

### 3. Multi-Phase Switching Converter

FIG. 2 is a block diagram illustrating the details of power supply 110 (of FIG. 1) in an embodiment of the present disclosure. Power supply 110 (of FIG. 1) is implemented as a multi-phase switching converter that generates two regulated power supplies (supply rails) Va (240) and Vb (250), and is shown containing phase controller 210, smart power stages (power stages) (SPS) SPSA-1 (220-1) through SPSA-6 (220-6), SPSB-1 (230-1) through SPSB-10 (230-10), inductors 225A-1 through 225A-6, 227B-1 through 227B-10, output capacitors 226A-1 through 226A-6, 228B-1 through 228B-10, and bootstrap capacitors 224A-1 through 224A-6, 224B-1 through 224B-10.

In the example, power supply Va (240) is generated by a 6-phase buck converter (there are six SPSs—220-1 through 220-6), while power supply Vb (250) is generated by a 10-phase buck converter (there are ten SPSs—230-1 through 230-10). Nodes/Paths 240 and 250 correspond to paths 112A and 112B respectively of FIG. 1. In the interest of conciseness, other power supply circuits that generate supplies on paths 113, 114 and 115 are not shown in FIG. 2. Thus, in the example embodiment, the total number of power stages in multi-phase switching converter 110 is 16, with six SPSs ‘assigned’ to rail Va (240) and ten SPSs assigned to rail Vb (250).

Each bootstrap capacitor associated with an SPS is shown connected between respective nodes SW and BOOT of the corresponding SPS. Thus, bootstrap capacitor 224A-1 is shown connected between switching node SWA-1 (221) and BOOTA-1 (215-1). Although bootstrap capacitor is shown connected external to each SPS, in alternative embodiments, bootstrap capacitor may be internal to the SPS.

Power stages 220-1 through 220-6 may be collectively or individually referred to below by respective numeral 220, as will be clear from the context. Also, signals/nodes 211-1 through 211-6, 213-1 through 213-6, 221-1 through 221-6 may be collectively or individually referred to by respective numerals 211, 213 and 221, as will also be clear from the context. Similar convention is followed for other blocks/components/signals throughout the disclosure. As a power stage is operative in a corresponding phase, the terms ‘power stage’ and ‘phase’ are used interchangeably in the present disclosure as will be clear from the context.

Each power stage may be implemented to contain a high-side switch, a low-side switch, gate-drive circuitry for the two switches, and other circuits. Examples of other circuits include, but are not limited to, temperature monitor circuit, inductor-current sense (or emulation) circuit, etc., to provide information, such as temperature of the SPS/power stage, magnitude of inductor current, etc., to phase controller 210. Each SPS receives a source of power as an input which is connected to the high-side switch. In FIG. 2, the supply source is numbered 201, and has a voltage Vin. In an embodiment, the value of Vin is 21 volts (V), and Va and Vb are respectively 3.3V and 1.8V. Each SPS is also shown receiving a voltage Vcc on path 202. In an embodiment, Vcc has a voltage of 3.3 V, and is provided by phase controller 210.

Each SPS communicates with phase controller 210 via corresponding signals PWM, CS and TMP. Thus, SPSA-1 is shown connected to phase controller 210 through signal/paths PWMA-1 (211), CSA-1 (213-1) and TMPA (214). SPSA-6 communicates with phase controller 210 via signals PWMA-6, CSA-6 and TMPA (214). Similarly, SPSB-1 is shown connected to phase controller 210 through signal/paths PWMB-1 (216-1), CSB-1 (218-1) and TMPB (219). SPSB-10 communicates with phase controller 210 via signals PWMB-10, CSB-10 and TMPB (219). The other SPSs would have similar connections with phase controller 210.

Signal TMP is an output from an SPS to phase controller 210, and provides information regarding the temperature in the SPS. Phase controller 210 may process the TMP signal (or the information contained in it) to adjust the current supplied by that phase, or for shut-down of the VRM. The TMP outputs of each phase of a converter are wired together, and a single input is connected to phase controller 210.

Signal CS (current-sense) is an input to phase controller 210 from an SPS, and contains information representing the magnitude of the inductor-current of that phase. The information can be in the form of a current, voltage, digital values, etc.

Signal PWM is an input to an SPS from phase controller 210, and may be viewed as a ‘phase control signal’ that controls the operation (ON and OFF states) of the power switches in the SPS of the corresponding phase. In an embodiment of the present disclosure, signal PWM is a pulse-width modulated (PWM) signal. Accordingly, in such an embodiment, signal PWM is a fixed-frequency, variable duty cycle signal. The duty cycle of the PWM signal is set by phase controller 210 and is designed to generate the desired power supply voltage and/or control/change the current supplied by that phase. For example, PWMA-1 (211-1) would have a duty cycle as required for the magnitude of Va (240) and the current to be provided by SPSA-1 (220-1). However, in general, signal PWM may have other characteristics depending on the specific implementation details of power supply 110.

For example, in another embodiment, phase controller 210 may employ a constant-ON-time control technique to generate Va. Accordingly, in such an embodiment, signal PWM is a variable frequency, fixed pulse-width (constant-ON-time) signal (i.e., pulse-frequency modulated signal, although the acronym PWM is still used herein to refer to such a signal for case of reference). The frequency of the signal is generally proportional to the desired regulated voltage (Va) and the load current. In yet another embodiment, signal PWM can change between a constant-ON time variable-frequency signal and a fixed-frequency pulse-width modulated signal, based on load current requirements, desired efficiency of power supply 110 and other considerations, as would be apparent to one skilled in the relevant arts.

A cycle/period of signal PWM consists of a first interval in which only the high-side (HS) switch of SPS is switched ON, and a second interval in which only the low-side (LS) switch of the SPS is switched ON. The PWM signal (or more typically, drive signals derived from the PWM signal) controls the opening and closing of high-side switch and low-side switch of the SPS. As is well known in the relevant arts, the PWM signals to each SPS of a same multi-phase voltage regulator are staggered/interleaved, i.e., delayed with respect to each other in phase such that typically no two high-side switches in the converter (i.e., respective SPSs) will be turned-ON at the same time instant. Such a technique is employed for reasons such as, for example, to ensure that the peak instantaneous current drawing from Vin is relatively low at all times, efficiency, reduced ripple in the output voltage, etc.

When logic LOW is detected by the SPS on signal PWM, the low-side switch is turned ON, and when logic HIGH is detected on signal PWM, the high-side switch is turned ON. Upon detecting a high-impedance (hi-Z) state (typically mid-rail voltage between power supply and ground) on signal PWM the SPS turns OFF both its high-side and the low-side switches. Thus, an SPS is said to be ‘active’ when the corresponding PWM signal is toggling between the HIGH and LOW states thereby contributing to generation of the output voltage and current, and is said to be ‘inactive’ when the corresponding PWM signal is in hi-Z state (mid-rail voltage between logic HIGH and logic-LOW voltages). In the inactive state, the power stage does not contribute to load-current.

Phase controller 210 controls the operation of the power stages via the signals noted above to provide various functions including regulating functions to enable the generation of regulated voltages Va and Vb by the corresponding sets of power stages. Accordingly, Va and Vb are shown as being provided as inputs to phase controller 210 to enable operation of one or more feedback loops within phase controller 210 to regulate Va and Vb. Phase controller 210 also receives inductor-current information (current flowing through each of the inductors) from each of the SPSs to enable various operations such as current-mode control of voltage regulation, current limiting, short circuit protection, and balancing the currents generated by each SPS of a same rail (e.g., rail Va) so as to make the currents from each SPS substantially equal in magnitude. Phase controller 210 may additionally perform various other operations which are not noted here in the interest of conciseness.

Phase controller 210 also operates to control the power stages to reduce/increase current output based on the load demand. Further, phase controller 210 may also receive signals from CPU 120 that indicate a desired power state (e.g., PS1, PS2, etc. noted above) in which the CPU operates from time to time. In response, phase controller 210 may activate/de-activate one or more of power stages 220 depending on the power state and the load-currents. Phase controller 210 staggers PWM signals (or delays turning ON high-side switches) of active stages.

Phase controller 210 may be designed to implement automatic phase management (APM). Accordingly, the specific number of phases activated by phase controller 210 can vary depending, for example, on the magnitude of load-current drawn from a rail (e.g., Va 240). In general, the smaller the load-current is, the lesser the number of phases activated and vice-versa. For example, phase controller 210 may maintain (in an internal memory) pre-determined load-current thresholds to determine the number of active phases. The thresholds are designed such that a given load-current requirement is met by substantially equal phase output currents, subject to the maximum current that can be provided by each individual phase.

As an example, for moderate load-currents drawn from rail Va (240), phase controller 210 may activate three power stages to generate Va (240), and maintain the other three power stages in an ‘inactive’ mode. When load-current increases from the previous value and crosses a pre-determined threshold, phase controller 210 may activate all six power stages assigned to rail Va (240). However, when load-current decreases from the previous value and falls below another pre-determined threshold, phase controller 210 may de-activate (drop or shed) two out of the three previously active power stages, thus keeping only one power stage active while maintaining the other five power stages in inactive mode. For example, assuming that each power stage is designed for a maximum current of 10 Amperes (A), phase controller 210 may employ only 1 power stage for load current of 0-10 A, 2 power stages for 10-20 A, and so on.

Thus, changes in Vin (201)/Va (240)/load-current, etc., may trigger a change in number of active and inactive power stages, and such change in number of active/inactive power stages is referred to as a ‘phase-change event’. Accordingly, in an interval bounded by two consecutive phase-change events, the number of active (and inactive phases) stages remains unchanged.

Referring back to the above example, for moderate load-currents, it is assumed that the set of active power stages contains the following power stages:
[SPSA-1 (220-1) through SPSA-3 (220-3)].

When load-current requirement becomes high, all six SPSs are activated resulting in the following set of active power stages:
[SPSA-1 (220-1) through SPSA-6 (220-6)].

When load-current requirement becomes moderate again, and three active stages are dropped, the set of active power stages is:
[SPSA-1 (220-1) through SPSA-3 (220-3)].

When load-current requirement drops further (very low load-currents drawn from rail-A (Va 240)) and only one stage is sufficient to support the load-current requirement), only SPS-1 (220-1) is kept active and remaining SPSs (SPS-2 (220-2) through SPS-6 (2206)) are de-activated.

When load-current requirement becomes moderate again, and two stages are added, the set of active stages contains:
[SPSA-1 (220-1) through SPSA-3 (220-3)].

It may be observed that, among the power stages in the set of active stages, phase controller 210 operates a power stage/phase (here, SPS-1 (220-1)) as ‘a master stage’, which remains active irrespective of load-current values drawn from rail Va (240). Thus, considering continuous operation for an extended period of time during which the load-current changes between the lowest level (requiring only one power stage to be active) and highest level (requiring all power stages assigned to the rail to be active), it may be appreciated that SPSA-1 (220-1) is active for the entire duration. It may also be appreciated that in the above-noted example, active durations of SPSA-2 (220-2) and SPSA-3 (220-3) are more than active durations of SPS-4 (220-4) through SPS-6 (220-6). Accordingly, power stages SPSA-1 (220-1) through SPSA-6 (220-6) assigned to rail Va (240) are stressed unequally since each of them is active for different durations with SPSA-1 (220-1) being the most stressed. This in turn may lead to a lower operating life for SPSA-1 (220-1) as compared to the other power stages.

Accordingly, there is a recognized need to change the master stage over time to equalize the stress between the different power stages. Phase controller 210 implemented according to aspects of the present disclosure changes a master stage, as described below with examples.

### 4. Flow-Chart

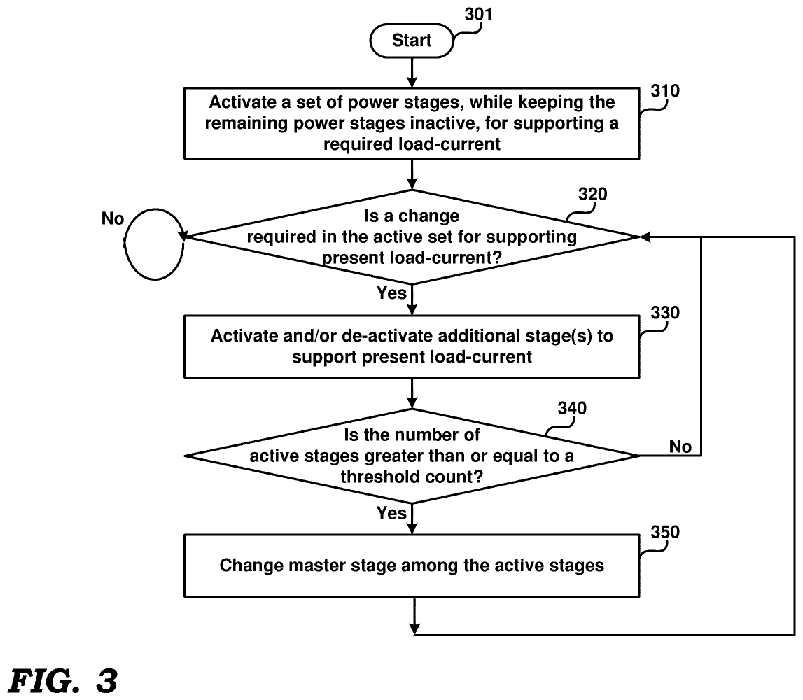

FIG. 3 is a flowchart illustrating the manner in which a phase controller of a multi-phase switching converter changes a master stage, according to an aspect of the present disclosure. The flow-chart is described with respect to the system/multi-phase switching converter of FIGS. 1 and 2 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some or all of the steps may be performed in a different sequence than that depicted below, as suited to the specific environment, as will be apparent to one skilled in the relevant arts. Many of such implementations are contemplated to be covered by several aspects of the present disclosure. The flow-chart begins in step 301, in which control immediately passes to step 310.

In step 310, phase controller 210 activates a set of power stages while keeping the remaining power stages (assigned to the rail) inactive for supporting a required load-current. Phase controller 210 operates one of the active power stages as a master stage.

In step 320, phase controller 210 checks if a change is required in the active set for supporting a present load-current. It may be appreciated that not all changes in load-current would require a corresponding change in the number of active stages. For example, phase controller 210 may activate a certain number of power stages for a corresponding range of load-currents.

If a change is required (value “YES”), control passes to step 330. If no such change is required (value “NO”), phase controller 210 continues to keep checking for such a change. There is no change in the set of active power stages.

In step 330, phase controller 210 activates and/or de-activates additional stage(s)/phase(s) to support present load-current. Specifically, if present load-current is greater than a pre-determined threshold, phase controller 210 activates additional power stage(s), and if present load-current is lesser than another pre-determined threshold, phase controller 210 de-activates one or more of the active power stage(s). Phase controller 210 continues to include the master stage in the (changed) set of active power stages.

In step 340, phase controller 210 checks if the number of active stages is greater than or equal to a threshold count. If the number is greater than or equal to the threshold count (value “YES”), control passes to step 350. If the number is lesser than the threshold count (value “NO”), control passes to step 320, in which phase controller 210 continues to check if a change is required in the active set.

In step 350, phase controller 210 changes the master stage among the active stages. In other words, the new master stage is selected to be one of the stages in the active set, which may avoid transients at the output. Control then passes to step 320.

While the change of step 350 is shown to be effected when the condition of step 340 is satisfied, in an alternative embodiment described below, the change is effected only after a threshold duration has elapsed since the previous change of master stage. In other words, the master stage is changed when both the conditions (elapsing of the threshold duration from a previous change and the step 340) are satisfied.

Thus, the phase controller of the present disclosure operates to change a master stage in a multi-phase switching converter. The implementation details of a phase controller that performs such changes in an embodiment of the present disclosure are provided next.

### 5. Phase Controller

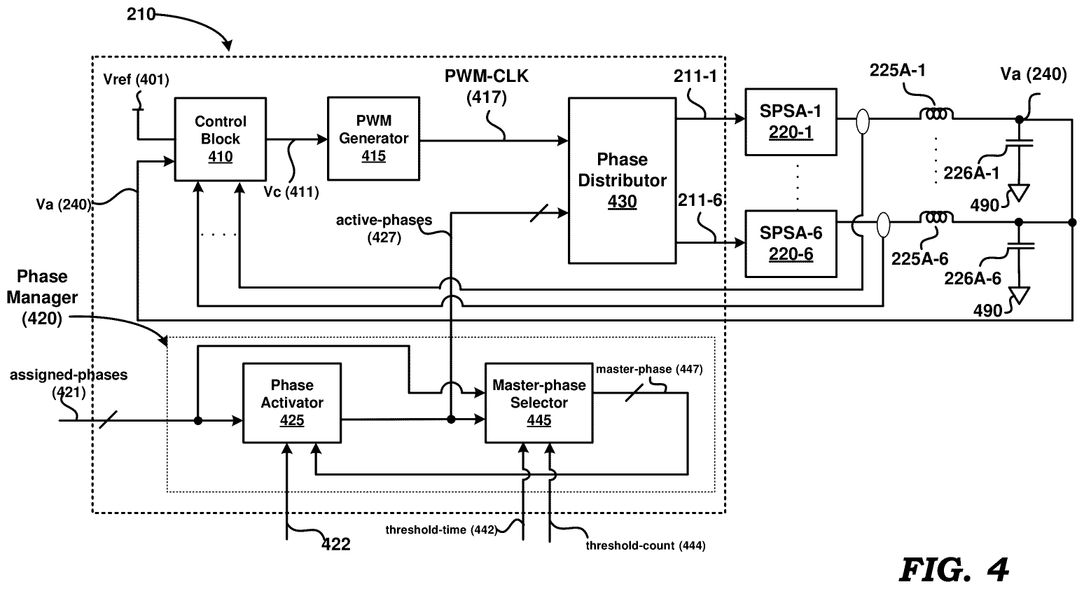

FIG. 4 is a block diagram illustrating the implementation details of a phase controller in an embodiment of the present disclosure. Phase controller 210 is shown as containing control block 410, PWM generator 415, phase manager 420, and phase distributor 430. Phase manager 420 in turn is shown as containing phase activator 425 and master-phase selector 445. Also shown in FIG. 4 for the purpose of case of understanding and clarity are the power stages 220-1 through 220-6, and the corresponding inductors and capacitors. Only the 6-phase converter containing power stages SPSA-1 (220-1) through SPSA-6 (220-6) together generating voltage Va (240), and the corresponding portions of phase controller 210 required for generating voltage Va (240) are depicted in FIG. 4 for ease of understanding.

Also, it is noted herein that only components as relevant to the understanding of the disclosure are depicted in FIG. 4. It is understood that phase controller 210 can contain more or fewer blocks than those shown in FIG. 4. For example, blocks 410, 415, 420 and 430 may be replicated (with appropriate inputs) to provide corresponding functionality for rail Vb (250). Further, phase controller 210 is described and illustrated as employing current-mode control technique merely for illustration. However, it must be understood that phase controller 210 can employ other types of control techniques. The internal blocks of phase controller 210 may be powered by a source, not shown.

Vref represents the desired target voltage to be supplied at node Va (240). Thus, Vref represents a stable reference DC voltage which is generated internally in phase controller 210 in a known way. Control block 410 receives reference voltage Vref (401), output voltage, Va (240) (or alternatively, some fraction of Va using a voltage divider network) and generates voltage Vc (411) representing the difference between voltages Vref (401) and Va (240), that forms one input to PWM generator 415. Control block 410 may internally contain components such as an error amplifier, a proportional-integral-derivative controller, etc., as is well known in the relevant arts. Control block 410 may be implemented in a known way.

PWM generator 415 generates signal PWM-CLK (417) based on signal Vc (411). PWM-CLK (417) may be a sequence of pulses (for example, of variable pulse-width), and whose frequency may be fixed in steady-state operation (e.g., when Vin, Va and load current are substantially constant) of multi-phase switching converter 110. However, during transients such as step changes in supply voltage, Vin (201), or load variations, frequency of PWM-CLK (417) may vary for a brief duration, as is well known in the relevant arts.

Signal PWM-CLK (417) clocks components (such as flip-flops) inside phase distributor 430, as will be described below in detail. As noted above, the periodicity (or frequency) and pulse-width of signal PWM-CLK (417) depends on the feedback signals (e.g., sensed inductor-currents, instantaneous magnitude of output voltage Va, etc.), as is well known in the relevant arts. Thus, blocks/components 410 and 415 may together be viewed as ‘a common-control-signal generator block’ designed to generate ‘common control signal’ PWM-CLK (417) such that voltage Va (240) is maintained at the desired magnitude as indicated by Vref (401). PWM generator 415 may internally contain components (not shown in FIG. 4) such as sawtooth waveform generator, comparators, etc. required to generate signal PWM-CLK (417), as is also well known in the relevant arts. PWM generator 415 may be implemented in a known way.

Phase activator 425 receives signal assigned-phases on path 421, signal master-phase on path 447 and input(s) on path 422 representing the load-current requirement, sensed inductor-currents of each power stage, overshoot/undershoot of voltage Va (240), etc., and generates signal ‘active-phases’ on path 427. Phase activator 425 controls the addition or shedding of phases (and therefore power stages) based on values received on path 422. Thus, phase activator 425 determines the number of phases to be activated and/or deactivated in order to support the load-current requirements in a given duration.

In an embodiment, each of signals assigned-phases (421), active-phases (427) and master-phase (447) is n bits wide, ‘n’ being the total number of phases in multi-phase switching converter 110. Thus, each bit of signals assigned-phases (421), active-phases (427) and master-phase (447) corresponds to a power stage. Signal assigned-phases (421) represents the phases that are assigned to a particular rail, and signal active-phases (427) represents the particular ones of the phases assigned to the rail that are activated to support load-current requirement of the rail in a given duration. Signal master-phase (447) represents the power stage that is operated as the master stage in the duration.

In the illustrative embodiment, phase activator 425 activates phases sequentially (from least-significant-bit, LSB to most-significant-bit, MSB) starting with an index equal to the index of master stage in signal master-phase (447), and taking into account roll-over of index as will be explained in further detail below. For example, out of 6 phases (SPSA-1, 220-1 through SPSA-6, 220-6) assigned to rail Va (240), assuming that phase activator 425 determines that 3 phases are required to be activated for supporting the load-current and master-phase is SPSA-2 (220-2), the active phases will be SPSA-2 (220-2) through SPS-4 (220-4). Phase activator 425 may be implemented, for example, using a state machine, although alternative techniques may be employed, as will be apparent to a skilled practitioner by reading the disclosure provided herein.

Master-phase selector (445) receives signals assigned-phases on path 421, active-phases on path 427, threshold-time on path 422 and threshold-count on path 444, and generates signal master-phase on path 447. Master-phase selector (445) operates to change the master stage among the active power stages to an active stage other than the present master stage when certain condition(s) are satisfied. In an embodiment, the conditions are:

Condition-1: When the number of active stages (as indicated by count of indices having a value ‘1’ in signal active-phases 427) is greater than or equal to a number (as indicated by value in signal threshold-count (444)).

Condition-2: When condition-1 holds for a duration exceeding a time period (as indicated by value in signal threshold-time (442)).

In an embodiment, threshold-count (444) equals the number of phases assigned to the rail, and master-phase selector (445) switches the master stage to the next higher index (going from LSB to MSB) (or to the left-most active-phase index in case of roll-over) in signal active-phases, 427. In other words, the process of changing/selecting the master stage continues in a round-robin sequence. Master-phase selector (445) may internally contain logic blocks such as a state machine and/or synchronous counters to achieve the functionality noted above. The first LSB index having a value of logic ‘1’ in signal assigned-phases (421) may be selected as the default master stage upon power-up of phase controller 210.

Thus, in the example embodiment of FIG. 2 (in which multi-phase switching converter 110 contains 6 phases assigned to rail Va (240) and 10 phases assigned to rail Vb, 250), n=16. Each of power stages/phases, therefore, is indexed in n-bit signal assigned-phases (421). Thus, with index 0 as the LSB and index 15 as the MSB, SPSA-1 (220-1) through SPSA-6 (220-6) may be indexed at positions 0 through 5 respectively, while SPSB-1 (230-1) through SPSB-10 (230-10) may be indexed at positions 6 through 15 respectively in signal assigned-phases (421), active-phases (427) and master-phase (447). Logic ‘1’ in an index in signal assigned-phases (421) indicates that the corresponding phase is available for use for rail Va (240), while a logic ‘0’ in an index indicates otherwise. Similar convention is followed for signals active-phases (427) and master-phase (447). It may be appreciated that only 1 index in signal master-phase (447) will have a logic value ‘1’ at a given time for a rail, representing the master stage for that rail. Phases may be assigned to rails at design time by a designer/user (via corresponding means) and such assignment information may be stored in non-volatile memory (not shown) of multi-phase switching converter 110.

Phase distributor 430 (PD 430) receives signal PWM-CLK on path 417, signal active-phases on path 427, and generates PWMA signals 211-1 through 211-6. PD 430 asserts a corresponding signal 211 in response to each pulse of signal PWM-CLK (417). In an embodiment, PD 430 operates to generate PWM signals (211) in a round-robin sequence for currently active power stages. Thus, for example, if power stages SPS-1 (220-1) though SPS-5 (220-5) are active in a certain duration, and SPS-6 (220-6) is de-activated in that duration, PD 430 asserts signals 211-1 through 211-5 in a round-robin sequence in response to the corresponding pulses of PWM-CLK (417) while keeping signal 211-6 in hi-Z state. In alternative embodiments employing constant-ON-time control technique, phase distributor 430 may generate intermediate output pulses which are provided to respective T-ON generators to generate corresponding fixed-width PWM signals 211.

The description is continued with an example implementation of a phase distributor implemented inside phase controller 210, in an embodiment of the present disclosure.

### 6. Phase Distributor

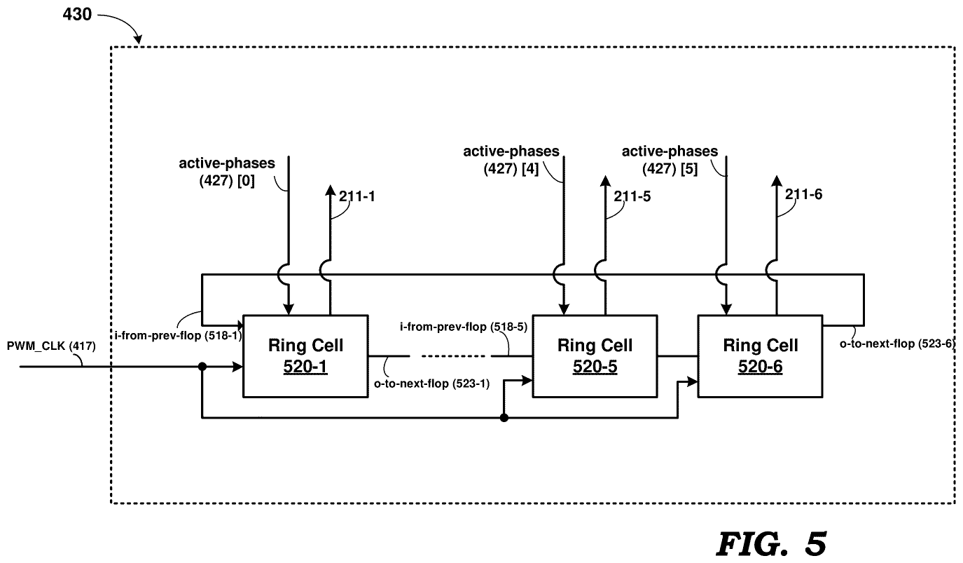

FIG. 5 is a diagram illustrating the implementation details of a phase distributor in an embodiment of the present disclosure. Phase distributor 430 is shown containing ring cells 520-1 through 520-6. It is noted that the implementation of phase distributor 430 shown in FIG. 5 is merely to illustrate. It is to be understood that alternative implementations of phase distributor 430 can contain more or fewer blocks than those shown in FIG. 5.

Each ring cell 520 corresponds to a respective power stage 220 (not shown in FIG. 5). Thus, six ring cells 520-1 through 520-6 are depicted in FIG. 5, with each ring cell corresponding to a respective SPS, as shown in the example embodiment of 6-phase buck converter of FIG. 2 generating voltage Va (240). Ring cell 520 is shown as receiving signal PWM-CLK on path 417, bit value corresponding to index of the respective power stage in signal active-phases (427), and input signal i-from-prev-flop on path 518, and is shown generating signals o-to-next-flop on path 523 and PWMA signal on path 211.

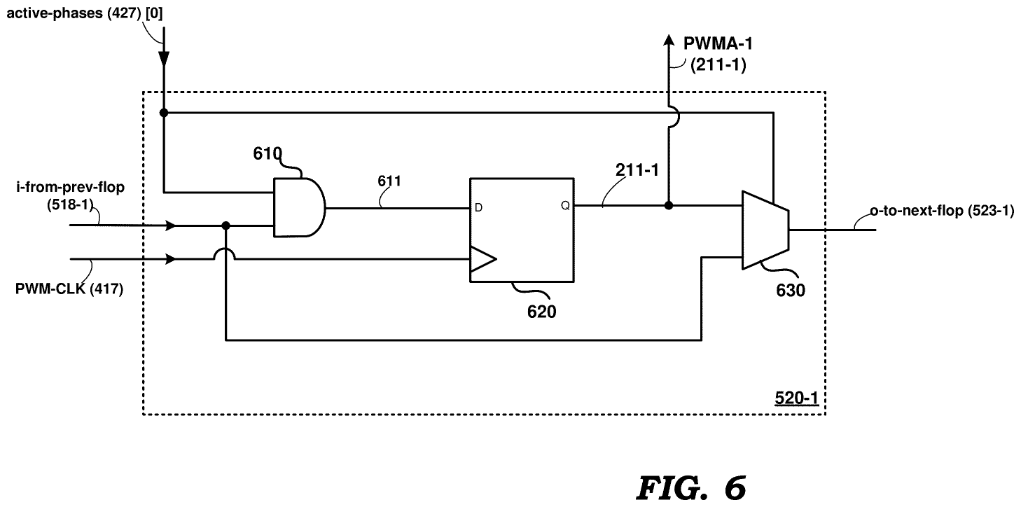

Ring cell 520 contains circuitry (described in detail below with respect to FIG. 6) to check if the corresponding power stage is active (based on signal received on path 427), and to toggle the PWM signal of the corresponding power stage based on input signal i-from-prev-flop received on path 518 and PWM-CLK received on path 417. In an embodiment, when a logic HIGH is received on path 518, then ring cell 520 generates a logic HIGH on path 523 at a next rising edge of PWM-CLK (417), and a logic LOW otherwise. As may be observed from FIG. 5, ring cells 520-1 through 520-6 are connected in a circular fashion such that the input signal (518) of each ring cell 520 corresponds to the output signal 523 of the previous ring cell, with the first ring cell (520-1) receiving the output signal (o-to-next-flop, 523-6) of the last ring cell (520-6). It is noted herein that in the present disclosure, a ring cell located immediately to the right of a ‘current’ ring cell (i.e., the ring cell that is being currently referred to) is referred to as the ‘next’ ring cell, and a ring cell located immediately to the left of the current ring cell is referred to as the ‘previous’ ring cell. Thus, ring cell 520-2 is the previous ring cell of ring cell 520-3 while ring cell 520-4 is the next ring cell of ring cell 520-3. Ring cell 520-1 is the left-most ring cell while ring cell 520-6 is the right-most ring cell.

The description is continued to illustrate the implementation details of a ring cell in an embodiment of the present disclosure.

### 7. Ring Cell

FIG. 6 is a block diagram illustrating the implementation details of a ring cell in an embodiment of the present disclosure. Ring cell 520-1 is shown in detail in FIG. 6. Ring cell 520-1 is shown as containing AND gate 610, MUX 630, and D flip-flop 620. The other ring cells can also be implemented to be similar to ring cell 520-1. Also, it is noted herein that only components as relevant to the understanding of the disclosure are depicted in FIG. 6. It is understood that ring cell 520 can contain more or fewer blocks than those shown in FIG. 6.

AND gate 610 receives signal active-phases (427) [0], signal i-from-prev-flop on path 518-1, and generates AND output on path 611. Accordingly, when both active-phases (427) [0] and i-from-prev-flop are logic HIGH, AND gate generates a logic HIGH.

Flip-flop 620 receives output of AND gate 610 on path 611 at its D input, and generates output (Q) on path 211. Flip-flop 620 is clocked by signal PWM-CLK (417). In an embodiment, flip-flop 620 is implemented as a positive edge triggered flip-flop, with active-low PR (preset) and CLR (clear) inputs (not shown in FIG. 6). Although Q-output of flip-flop 620 is shown as being provided as signal PWM (211) to respective SPSs (220) in the illustrative embodiment, output of an AND gate (not shown in FIG. 6) operating with inputs Q-output and signal PWM-CLK (417) may be provided as PWM signal (211) in alternative embodiments.

MUX 630 receives Q-output of flip-flop 620 on path 211-1 and signal i-from-prev-flop on path 518-1, and forwards one of signals 211-1 and 518-1 on path 523-1 as an output (MUX output/o-to-next-flop) based on the logic value of select signal active-phases (427) [0]. In an embodiment, when signal active-phases (427) [0] is a logic HIGH, Q-output 211-1 is selected as MUX output on path 523-1, while when signal active-phases (427) [0] is a logic LOW, signal i-from-prev-flop (518-1) is selected as MUX output on path 523-1. In other words, when the SPS corresponding to ring cell 520 is not active, input signal (518) indicating active status of the previous ring cell is forwarded on path 523.

Thus, ring cells 520-1 through 520-6 operate to shift logic HIGH on Q-output of flip-flops (thereby activating the different phases (SPSA-1 220-1 through SPSA-6 220-6)) in a round-robin sequence. At every low-to-high transition of signal PWM-CLK (417), the position of the active flip-flop (620) within ring cells 520 of phase distributor 430 advances by one location to the right or rolls back to the leftmost flip-flop. Thus, there is one (and only one) active flip-flop (Q-output is a logic HIGH) at any instant of time.

The first active flip-flop in the round-robin sequence (from where logic HIGH is shifted in round-robin sequence) corresponds to the left-most active phase (indicated by corresponding index in signal active-phases, 427), which also represents the master stage. Preset (PR) input of flip-flop 620 in ring cell 520 corresponding to the left-most active phase, and clear (CLR) inputs of other flip-flops are accordingly set to logic LOW after a phase-change event.

The description is continued to illustrate the manner in which phase management is performed in an embodiment of the present disclosure.

### 8. Phase Management

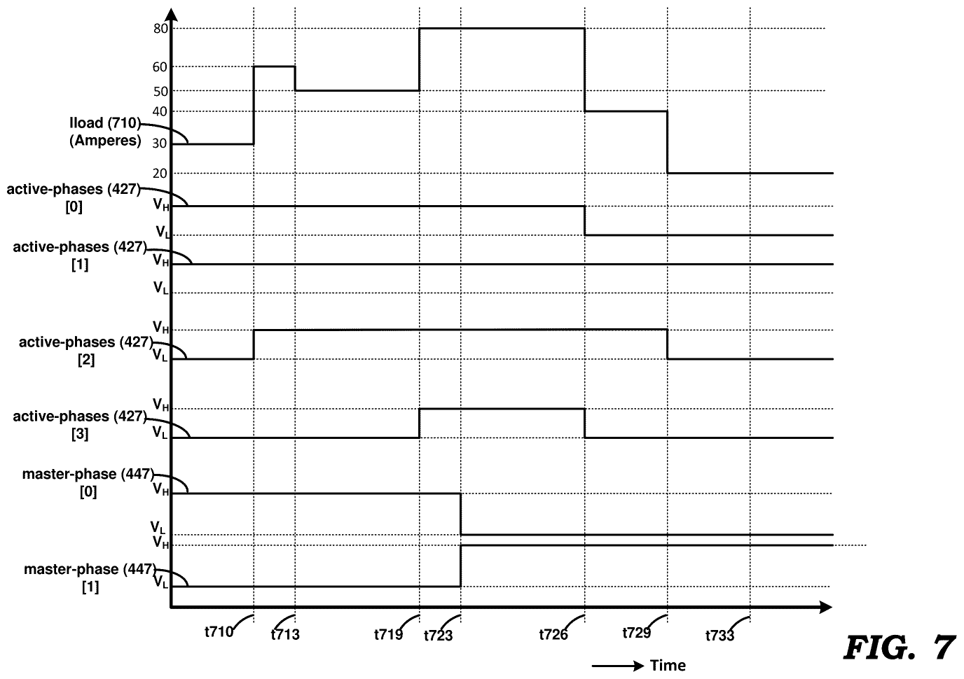

FIG. 7 is a timing diagram (not to scale) illustrating phase management and change in master stage for rail Va (240), in an embodiment of the present disclosure. Example waveforms of load-current (Iload) (710) drawn from rail Va (240), and signals active-phases (427) [0] . . . [3] and master-phase (447) [0] . . . [1] are shown in FIG. 7. It is noted herein that only waveforms as relevant to the understanding of the disclosure are depicted in FIG. 7. The logic states of other waveforms will be apparent to a skilled practitioner by reading the disclosure herein. Voltages V_{L} and V_{H} represent voltage values for logic LOW and logic HIGH respectively. In an embodiment, voltage V_{L} equals zero V, and V_{H} equals 3.3V.

For the sake of simplicity, it is assumed in the example illustration of FIG. 7 that only 4 SPSs (SPSA-1 (220-1) through SPSA-4 (220-4) (FIG. 2) are contained in multi-phase switching converter 110, and all four phases are assigned to rail Va (240). Thus, n=4. Signal assigned-phases (421) is [1111], with LSB index position (i.e., 0) corresponding to SPSA-1 (220-1) and MSB index position (i.e., 3) corresponding to SPSA-4 (220-4). In the illustrative embodiment, threshold-count (444) equals 4.

Prior to time t710, it is assumed that load-current requirement is 30 Amperes (A). Based on the load-current requirement (as indicated by value(s) on path 422), phase activator 425 has activated two power stages-SPSA-1 (220-1) and SPSA-2 (220-2). Thus, prior to t710:
The set of active power stages consists of SPSA-1 (220-1) and SPSA-2 (220-2),
The set of inactive power stages consists of SPSA-3 (220-3) and SPSA-4 (220-4),
Signal active-phases (427) is: [0011].

Also, prior to t710, it is assumed that SPSA-1 (220-1) is operating as the master stage. Thus, signal master-phase (447) is: [0001]. Accordingly, in FIG. 7, prior to t710:
Active-phases (427) [0] and active-phases (427) [1] are shown to be at logic HIGH,
Active-phases (427) [2] and active-phases (427) [3] are shown to be at logic LOW,
Master-phase (447) [0] is shown to be at logic HIGH and master-phase (447) [1] is shown to be at logic LOW. Master-phase (447) [2] and master-phase (447) [3] (not shown in FIG. 7) are also at logic LOW.

At time t710, it is assumed that phase controller 210 receives signals from CPU 120 indicating load-current requirement of 60 A. Although changes in load-current are shown as step-changes in FIG. 7 for case of illustration, it is understood that such changes occur in non-zero time intervals, as will be apparent to a skilled practitioner.

Phase activator 425 determines that a change is required in the active set of power stages for supporting the present load-current (i.e., 60 A), as described in step 320 of the flow-chart of FIG. 3. Thus, phase activator 425 activates phases sequentially (from LSB to MSB) starting with the index of master stage in signal master-phase (447), here SPSA-1 (220-1). Thus, phase activator 425 activates SPSA-3 (220-3) in addition to SPSA-1 (220-1) and SPSA-2 (220-2). Accordingly, starting at t710:
The set of active power stages consists of SPSA-1 (220-1) through SPSA-3 (220-3),
The set of inactive power stages consists of SPSA-4 (220-4),
Signal active-phases (427) is: [0111],
Active-phases (427) [0] and active-phases (427) [1] continue to be at logic HIGH,
Active-phases (427) [2] transitions from logic LOW to logic HIGH, and
Active-phases (427) [3] continue to be at logic LOW.

Master-phase selector (445) checks if the number of active phases is greater than or equal to threshold-count (444), as described in step 340 of the flow-chart. Since the condition is not satisfied, master-phase selector (445) does not change the master stage. Accordingly, starting at t710:
Signal master-phase (447) continues to be [0001],
Master-phase (447) [0] continues to be at logic HIGH, and
Master-phase (447) [1] continues to be at logic LOW.

At time t713, phase controller 210 receives signals from CPU 120 indicating load-current requirement of 50 A. However, phase activator 425 determines that no change is required in the active set for supporting the present load-current. Accordingly, no changes are shown in waveforms of signals 427 and 447 at t713.

At time t719, phase controller 210 receives signals from CPU 120 indicating load-current requirement of 80 A. Phase activator 425 determines that all phases assigned to the rail need to be activated to meet the load-current demand. Thus, phase activator 425 activates SPSA-4 (220-4) in addition to SPSA-1 (220-1) through SPSA-3 (220-3). Accordingly, starting at t719:
The set of active power stages consists of SPSA-1 (220-1) through SPSA-4 (220-4),
There are no inactive power stages,
Signal active-phases (427) is: [1111],
Active-phases (427) [0 . . . 2] continue to be at logic HIGH, and
Active-phases (427) [3] transitions from logic LOW to logic HIGH.

Master-phase selector (445) checks if the number of active phases is greater than or equal to threshold-count (444). Since condition-1 noted above is satisfied, master-phase selector (445) waits for a duration as indicated by value threshold-time (442) before changing the master stage. It is assumed that the duration of time interval t719 to t723 is equal to threshold-time (442). Thus, at t723, condition-2 noted above is satisfied, and master-phase selector (445) switches the master stage to the next higher index (going from LSB to MSB), i.e., changes the master stage from SPSA-1 (220-1) to SPSA-2 (220-2). Accordingly, starting at t723:
Signal master-phase (447) is [0010],
Master-phase (447) [0] transitions from logic HIGH to logic LOW, and
Master-phase (447) [1] transitions from logic LOW to logic HIGH.

Although in the illustrative embodiment master-phase selector (445) is shown as waiting for threshold-time (442) before changing master stage, it may be appreciated that in alternative embodiments, master-phase selector (445) may change the master stage at t719 (at the occurrence of phase-change event) without waiting for any threshold time.

At time t726, load-current requirement of CPU 120 reduces to 40 A. Phase activator 425 determines that a fewer number of phases (e.g., 2 phases) are sufficient for supporting the present load-current. Thus, phase activator 425 activates phases sequentially (from LSB to MSB) starting with the index of master stage in signal master-phase (447), now SPSA-2 (220-2). Thus, phase activator 425 keeps SPSA-2 (220-2) and SPSA-3 (220-3) active, and drops SPSA-1 (220-1) and SPSA-4 (220-4) from the active set. Accordingly, starting at t726:
The set of active power stages consists of SPSA-2 (220-2) and SPSA-3 (220-3),
The set of inactive power stages consists of SPSA-1 (220-1) and SPSA-4 (220-4),
Signal active-phases (427) is: [0110],
Active-phases (427) [0] and active-phases (427) [3] transition from logic HIGH to logic LOW, and
Active-phases (427) [1] and active-phases (427) [2] continue to be at logic HIGH.

Master-phase selector (445) checks if the number of active phases is greater than or equal to threshold-count (444) after the change in active-phases (427). Since the condition is not satisfied, master-phase selector (445) does not change the master stage. Accordingly, starting at t726:
Signal master-phase (447) continues to be [0010],
Master-phase (447) [0] continues to be at logic LOW, and
Master-phase (447) [1] continues to be at logic HIGH.

At time t729, load-current requirement of CPU 120 reduces further to 20 A. Phase activator 425 determines that a single phase is sufficient for supporting the present load-current. Thus, phase activator 425 activates phase(s) sequentially (from LSB to MSB) with starting index as indicated by index of master stage in signal master-phase (447), now SPSA-2 (220-2). Thus, phase activator 425 keeps SPSA-2 (220-2) active, and drops the previously-active phase, SPSA-3 (220-3), from the active set. Accordingly, starting at t729:
The set of active power stages consists of SPSA-2 (220-2),
The set of inactive power stages consists of SPSA-1 (220-1), SPSA-3 (220-3) and SPSA-4 (220-4),
Signal active-phases (427) is: [0010],
Active-phases (427) [0] and active-phases (427) [3] continue to be at logic LOW,
Active-phases (427) [1] continues to be at logic HIGH, and
Active-phases (427) [2] transitions from logic HIGH to logic LOW.

It may be appreciated that the previous master stage (SPSA-1, 220-1) is dropped from the set of active stages, thus reducing stress on this power stage. Had the master stage continued to be SPSA-1 (220-1), the phase would have been included in the active set of power stages irrespective of load-current changes, potentially resulting in reduced operating life of the power stage.

Master-phase selector (445) checks if the number of active phases is greater than or equal to threshold-count (444) after the change in active-phases (427). Since the condition is not satisfied, master-phase selector (445) does not change the master stage. Accordingly, starting at t729:
Signal master-phase (447) continues to be [0010],
Master-phase (447) [0] continues to be at logic LOW, and
Master-phase (447) [1] continues to be at logic HIGH.

Although the illustrative embodiment illustrates threshold-count (444) as being the total number (maximum count) of phases assigned to the rail, aspects of the present disclosure can be equally well applied when threshold-count (444) is a non-zero number less than the maximum count of assigned phases. It may be appreciated that changing the master stage when the number of active power stages exceeds a threshold count may prevent transients in output voltage Va (240) as compared to changing the master stage, when, for example, there is a single active power stage. In other words, changing the master stage when only a single power stage is active would entail de-activating the current active power stage and activating the newly selected master stage, leading to transients in output voltage, Va (240). Also, since a change in the master stage according to aspects of the present disclosure is only a change in an internal signal/register, such change is not reflected in the output current/voltage.

Further, although the illustrative embodiment, for the sake of simplicity, describes selecting the master stage in a round-robin sequence, aspects of the present disclosure are applicable when other techniques (such as changing the master stage randomly, or based on parameters such as sensed current from power stages, active duration of power stages, etc.) are employed when selecting the master stage, as will be apparent to a skilled practitioner by reading the disclosure herein.

The description is continued to illustrate two example scenarios of changing the master-phase in a 16-phase multi-phase switching converter.

### 9. Example Scenarios of Changing Master Stage

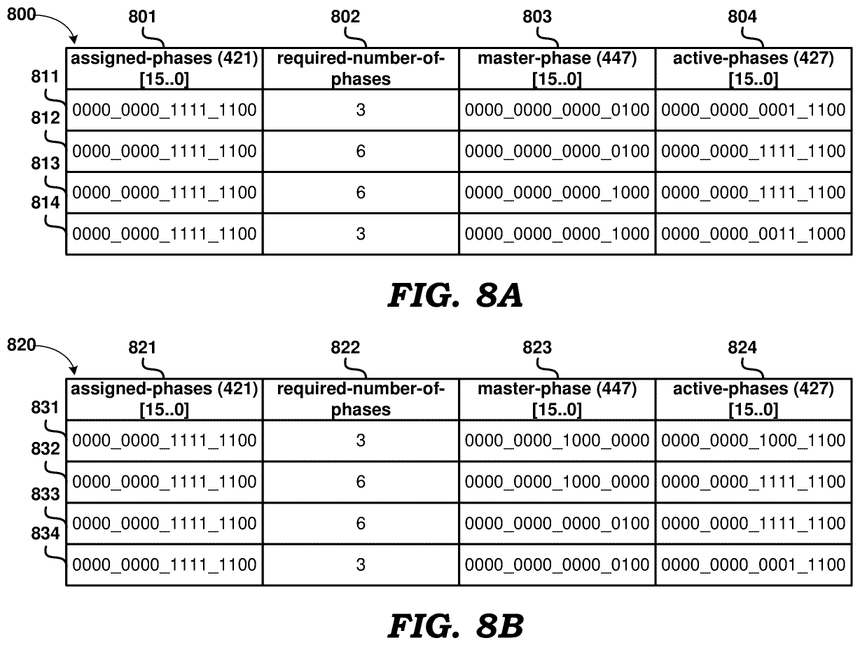

FIGS. 8A and 8B depict tables illustrating changing the master stage in two example scenarios. Specifically, tables 800 and 820 are shown as containing 4 rows each (rows 811-814 in FIG. 8A, and rows 831-834 in FIG. 8B). Columns 801/821, 803/823 and 804/824 respectively depict the values of signals assigned-phases (421), master-phase (447) and active-phases (427). Columns 802/822 depict the required number of phases (as determined by phase activator 425 of FIG. 4) for supporting a load-current demand.

In the illustrative embodiments of FIGS. 8A and 8B, it is assumed that 6 phases are assigned to the example rail, with index positions 2-7 (as indicated by logic ‘1’ in rows 811-814/831-834, columns 801/821). It is also assumed that threshold-count (444) (not shown in FIGS. 8A and 8B) equals 6.

Row 811 depicts that the current master stage (column 803) is at index position 2, and required-number-of-phases is 3. Thus, starting from index 2, phase activator 425 counts 3, resulting in active-phases (427) with logic ‘1’ in index positions 2-4 (column 804).

Row 812 depicts an increased load-current demand from the previous value, and accordingly, required-number-of-phases is 6. Thus, starting from index 2, phase activator 425 counts 6, resulting in active-phases (427) with logic ‘1’ in index positions 2-7. It may be observed that there is no change in master-phase (447). It is assumed that this condition (of active-phases (427)>=threshold-count (444) persists for threshold-time (442)). Accordingly, as depicted in row 813, the master stage is shifted to index position 3. It may be noted that there is no change in active-phases (427) from row 812 to row 813.

Row 814 depicts a decreased load-current demand from the previous value, and accordingly, required-number-of-phases down to 3 from 6. Now, phase activator 425 counts 3 starting from index 3 (new master stage index), resulting in active-phases (427) with logic ‘1’ in index positions 3-5.

Continuing to change master stage in the round-robin sequence noted above, after a certain time, values of signals are as depicted in row 831 of FIG. 8B with master stage in index 7 (last index with logic ‘1’ in assigned-phases (421)).

Row 832 depicts an increased load-current demand from the previous value, and accordingly, required-number-of-phases is 6. Thus, starting from index 7, phase activator 425 counts 6. However, since index 7 represents the index of the last phase assigned to the rail, phase activator 425 rolls back and counts from index 2, resulting in active-phases (427) with logic ‘1’ in index positions 2-7.

It is assumed that this condition (of active-phases (427)>=threshold-count (444) persists for threshold-time (442)). Accordingly, master-phase selector (445) determines to change the master stage to the next higher index. However, since index 7 (of the current master stage) represents the index of the last assigned phase, master-phase selector (445) rolls back and sets master stage at index position 2, as depicted in row 833. It may be noted that there is no change in active-phases (427) from row 832 to row 833.

Row 834 depicts a decreased load-current demand from the previous value, and accordingly, required-number-of-phases down to 3 from 6. Now, phase activator 425 counts 3 starting from index 2 (new master stage index), resulting in active-phases (427) with logic ‘1’ in index positions 2-4.

Thus, aspects of the present disclosure operate to change the master stage in a multi-phase switching converter.

### 10. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 4, 5 and 6, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-type MOS) transistors, while also interchanging the connections to power and ground terminals.

Accordingly, in the instant application, the power and ground terminals are referred to as constant reference potentials, the source (emitter) and drain (collector) terminals of transistors (through which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A method performed in a phase controller of a multi-phase switching converter, said phase controller configured to provide corresponding phase control signals to a plurality of power stages that together operate to provide a regulated supply voltage from an input voltage, said method comprising:
activating a set of power stages in said plurality of power stages and keeping inactive remaining ones of said plurality of power stages, wherein a first power stage in said set of power stages is operated as a master stage;
changing said set of power stages when required for supporting a present load-current;
if a number of stages in said set of power stages is greater than or equal to a threshold count, selecting as the master stage a power stage other than said first power stage among said changed set of power stages.

2. The method of claim 1, wherein said multi-phase switching converter comprises a plurality of rails and wherein a corresponding master stage is operable for each of said plurality of rails,
wherein said threshold count equals a total number of power stages in said plurality of power stages such that the master stage corresponding to a first rail of said plurality of rails is changed only when all power stages assigned to said first rail are operative as said changed set of power stages, wherein said first rail provides said regulated supply voltage.

3. The method of claim 1, wherein said master stage is changed when the number of stages in said changed set of power stages is greater than or equal to said threshold count for a threshold time duration.

4. The method of claim 1, wherein said master stage is selected in a round-robin sequence among power stages in said changed set of power stages.

5. The method of claim 4, wherein said master stage is indicated by a first signal comprising a first plurality of bits, with each bit representing a respective index in said first signal and corresponding to a respective power stage of said plurality of power stages,
wherein a value of one in an index of said first signal indicates that the corresponding power stage is the master stage.

6. The method of claim 5, wherein said set of active power stages is indicated by a second signal comprising a second plurality of bits, with each bit representing a respective index in said second signal and corresponding to a respective power stage of said plurality of power stages,
wherein a value of one in an index of said second signal indicates that the corresponding power stage is active and a value of zero in an index of said third signal indicates otherwise,
wherein the index of each power stage of said plurality of power stages in said second signal is the same as that in said first signal,
wherein said method comprises:
activating a required number of power stages sequentially with starting index equal to that corresponding to said master stage in said first signal.

7. A phase controller of a multi-phase switching converter, said phase controller configured to provide corresponding phase control signals to a plurality of power stages that together operate to provide a regulated supply voltage from an input voltage, said phase controller comprising:
a master-control-signal generator block coupled to receive said regulated supply voltage and a reference voltage of a desired magnitude, and to generate a common control signal having transitions with a period generated based on difference in magnitude between said reference voltage and said regulated supply voltage;
a phase distributor to receive said common control signal and to generate said corresponding phase control signals timed according to said transitions of said common control signal;
a phase activator to receive information comprising present load-current and to generate active-phases signal indicating a set of power stages to be driven to an active state to support said present load-current; and
a master-phase selector to receive said active-phases signal and to generate a master-phase signal indicating the power stage in said set of power stages to be operated as a master stage,
wherein said phase activator changes said set of power stages when required for supporting said present load-current,
if said number of stages is greater than or equal to a threshold count, said master-phase selector selects a power stage other than said first power stage among said changed set of power stages.

8. The phase controller of claim 7, wherein said multi-phase switching converter comprises a plurality of rails and wherein a corresponding master stage is operable for each of said plurality of rails,
wherein said threshold count equals a total number of power stages in said plurality of power stages such that the master stage corresponding to a first rail is changed only when all power stages assigned to said first rail are operative as said changed set of power stages, wherein said first rail provides said regulated supply voltage.

9. The phase controller of claim 7, wherein said master-phase selector changes said master stage when the number of stages in said changed set of power stages is greater than or equal to said threshold count for a threshold time duration.

10. The phase controller of claim 7, wherein said master-phase selector selects said master stage in a round-robin sequence among power stages in said changed set of power stages.

11. The phase controller of claim 10, wherein said master-phase signal comprises a first plurality of bits, with each bit representing a respective index in said master-phase signal and corresponding to a respective power stage of said plurality of power stages,
wherein a value of one in an index of said master-phase signal indicates that the corresponding power stage is said master stage.

12. The phase controller of claim 11, wherein said active-phases signal comprises a second plurality of bits, with each bit representing a respective index in said active-phases signal and corresponding to a respective power stage of said plurality of power stages,
wherein a value of one in an index of said active-phases signal indicates that the corresponding power stage is activated and a value of zero in an index of said active-phases signal indicates otherwise,
wherein said phase activator activates the required number of power stages sequentially with starting index equal to that corresponding to said master stage in said master-phase signal,
wherein the index of each power stage of said plurality of power stages in said active-phases signal is the same as that in said master-phase signal.

13. The phase controller of claim 12, wherein said phase distributor comprises:
a plurality of ring cells, wherein each ring cell corresponds to a respective power stage of said plurality of power stages, wherein each ring cell of said plurality of ring cells is coupled to receive an input-flop signal and a corresponding bit of said active-phases signal, and to generate an output-flop signal,
wherein said plurality of ring cells are connected in a circular fashion such that the input-flop signal of each ring cell corresponds to the output-flop signal of the previous ring cell, wherein each ring cell comprises a flip-flop clocked by said common control signal.

14. A multi-phase switching converter to provide a regulated supply voltage from an input voltage, said multi-phase switching converter comprising:
a plurality of power stages, each power stage to receive a respective phase control signal and to connect said input voltage to a corresponding inductor when said respective phase control signal is in a first state and to disconnect said input voltage from said corresponding inductor when said respective phase control signal is in a second state;
a phase controller to generate said phase control signals, said phase controller comprising:
a common-control-signal generator block coupled to receive said regulated supply voltage and a reference voltage of a desired magnitude, and to generate a common control signal having transitions with a period generated based on difference in magnitude between said reference voltage and said regulated supply voltage;
a phase distributor to receive said common control signal and to generate said corresponding phase control signals timed according to said transitions of said common control signal;
a phase activator to receive information comprising present load-current and to generate active-phases signal indicating a set of power stages to be driven to an active state to support said present load-current; and
a master-phase selector to receive said active-phases signal and to generate a master-phase signal indicating the power stage in said first set of power stages to be operated as a master stage,
wherein said phase activator changes said set of power stages when required for supporting said present load-current,
if said number of stages is greater than or equal to a threshold count, said master-phase selector selects a power stage other than said first power stage among said changed set of power stages.

15. The multi-phase switching converter of claim 14, wherein said multi-phase switching converter comprises a plurality of rails and wherein a corresponding master stage is operable for each of said plurality of rails,
wherein said threshold count equals a total number of power stages in said plurality of power stages such that the master stage corresponding to a first rail is changed only when all power stages assigned to said first rail are operative as said changed set of power stages, wherein said first rail provides said regulated supply voltage.

16. The multi-phase switching converter of claim 14, wherein said master-phase selector changes said master stage when the number of stages in said changed set of power stages is greater than or equal to said threshold count for a threshold time duration.

17. The multi-phase switching converter of claim 14, wherein said master-phase selector selects said master stage in a round-robin sequence among power stages in said changed set of power stages.

18. The multi-phase switching converter of claim 17, wherein said master-phase signal comprises a first plurality of bits, with each bit representing a respective index in said master-phase signal and corresponding to a respective power stage of said plurality of power stages,
wherein a value of one in an index of said master-phase signal indicates that the corresponding power stage is said master stage.

19. The multi-phase switching converter of claim 18, wherein said active-phases signal comprises a second plurality of bits, with each bit representing a respective index in said active-phases signal and corresponding to a respective power stage of said plurality of power stages,
wherein a value of one in an index of said active-phases signal indicates that the corresponding power stage is activated and a value of zero in an index of said active-phases signal indicates otherwise,
wherein the index of each power stage of said plurality of power stages in said master-phase signal is the same as that in said active-phases signal,
wherein said phase activator activates the required number of power stages sequentially with starting index equal to that corresponding to said master stage in said master-phase signal.

20. The multi-phase switching converter of claim 19, wherein said phase distributor comprises:
a plurality of ring cells, wherein each ring cell corresponds to a respective power stage of said plurality of power stages, wherein each ring cell of said plurality of ring cells is coupled to receive an input-flop signal and a corresponding bit of said active-phases signal, and to generate an output-flop signal,
wherein said plurality of ring cells are connected in a circular fashion such that the input-flop signal of each ring cell corresponds to the output-flop signal of the previous ring cell, wherein each ring cell comprises a flip-flop clocked by said common control signal.
